(19) United States
(12) Patent Application Publication
(10) Pub. No.: US 2011/0262595 A1
(43) Pub. Date: Oct. 27, 2011

(54) ANTIOXIDANT NUTRITIONAL SUPPLEMENT

(75) Inventor: Jong Sim LEE, Seongnam (KR)

(73) Assignee: NATURALIFE ASIA CO., LTD., Seoul (KR)

(21) Appl. No.: 12/764,306

(22) Filed: Apr. 21, 2010

(51) Int. Cl. A23L 1/29

(52) U.S. Cl. 426/63; 426/541

(57) ABSTRACT

Disclosed is an antioxidant nutritional supplement including a vegetable mixture and a fruit mixture each having an antioxidant effect as indispensible ingredients. Since the antioxidant nutritional supplement is not a drug, it may have a low price and it may not have medical side effects even if it is taken for a long period of time. Furthermore, since the antioxidant nutritional supplement includes various nutrients with balance, it may allow a user to be provided with nutrients which may lack to modern people, without causing a difficulty in taking other nutritional supplements.

### BACKGROUND OF THE INVENTION

1. Field of the Invention

The present invention relates to an antioxidant nutritional supplement, and particularly, to an antioxidant nutritional supplement including a vegetable mixture and a fruit mixture each having an antioxidant effect as indispensible ingredients.

2. Background of the Invention

Oxygen introduced to a human's body through inhalation circulates in the body to generate energy. This energy is made from cells of the body, and nutrients (sugars and fats) are uses as a source of the energy. And, the oxygen serves to convert the source into energy. During these processes, oxygen free radicals are generated. These oxygen free radicals may attack and damage neighboring cells due to their unstable characteristic. More concretely, even if oxygen and energy are absolutely necessary to a human body, the oxygen which is good for the human's body may be harmful to the human's body while being converted into the energy.

Cells attacked by the oxygen free radicals may lose their own functions or may be transmuted. Once the cells lose physiological functions, the human body can not maintain its own system. Especially, brain cells, blood vessel cells, and skin cells are susceptible to the oxygen free radicals. A healthy human body has an antioxidant system capable of removing oxygen free radicals which continuously occur, or capable of reproduce damaged cells. This antioxidant system removes oxygen free radicals generated from the body, by converting into materials having no attack characteristic.

If the amount of the oxygen free radicals is drastically increased due to ultraviolet rays, environmental pollution materials, etc. or if a function to remove the oxygen free radicals is degraded as a man gets older, an imbalance may occur between generation and removal of the oxygen free radicals. More concretely, a homeostasis is collapsed to cause cells inside the human body to be attacked by the oxygen free radicals. In order to protect the human body from the oxygen free radicals, it is preferable to take a large amount of foods having rich antioxidants, and to remove many factors which increase the oxygen free radicals.

However, antioxidant synthesized drugs may badly influence on digestive organs, and may cause economical losses or medical side effects when taken for a long period of time. Furthermore, in order to obtain an antioxidant effect from natural foods, a great amount of foods are required, which may not be practical.

### SUMMARY OF THE INVENTION

Therefore, an object of the present invention is to provide an antioxidant nutritional supplement capable of maintaining a nutritional balance by including a vegetable mixture and a fruit mixture each having an antioxidant effect, as indispensable ingredients, and capable of having no side effects and disadvantages in medical and economical aspects when taken for a long period of time.

Another object of the present invention is to provide an antioxidant nutritional supplement capable of being further provided with other nutrients such as vitamins which may lack to modern people.

To achieve these and other advantages and in accordance with the purpose of the present invention, as embodied and broadly described herein, there is provided an antioxidant nutritional supplement, comprising: a vegetable mixture including 10 parts by weight of parsley juice powder, 1˜100 parts by weight of kale juice powder, 1˜100 parts by weight of spinach juice powder, 1˜100 parts by weight of wheat grass juice powder, 1˜100 parts by weight of brussels sprout juice powder, 1˜100 parts by weight of asparagus juice powder, 1˜100 parts by weight of broccoli juice powder, 1˜100 parts by weight of cauliflower juice powder, 1˜100 parts by weight of beet juice powder, 1˜100 parts by weight of carrot juice powder, 1˜100 parts by weight of cabbage juice powder, and 1˜100 parts by weight of garlic juice powder; and a fruit mixture including 10 parts by weight of plum juice powder, 1˜100 parts by weight of cranberry juice powder, 1˜100 parts by weight of blueberry juice powder, 1˜100 parts by weight of strawberry juice powder, 1˜100 parts by weight of blackberry juice powder, 1˜100 parts by weight of bilberry juice powder, 1˜100 parts by weight of cherry juice powder, 1˜100 parts by weight of apricot juice powder, 1˜100 parts by weight of papaya juice powder, 1˜100 parts by weight of orange juice powder, 1˜100 parts by weight of grape juice powder, and 1˜100 parts by weight of pineapple juice powder, wherein a weight ratio between the vegetable mixture and the fruit mixture is 10:7˜13.

The antioxidant nutritional supplement according to the present invention may further comprise: based on 100 parts by weight of the vegetable mixture, 12.5˜23.5 parts by weight of Cordyceps mushroom; 12.5˜23.5 parts by weight of Reishi mushroom; 12.5˜23.5 parts by weight of Shiitake mushroom; 12.5˜23.5 parts by weight of Hiratake mushroom; 3.3˜6.5 parts by weight of Maitake mushroom; 3.3˜6.5 parts by weight of Yamabushitake mushroom; 2˜4 parts by weight of Himematsutake mushroom; 2˜4 parts by weight of Kawaratake mushroom; 2˜4 parts by weight of Chaga mushroom; 2˜4 parts by weight of Zhu Ling mushroom; 2˜4 parts by weight of Agarikon mushroom; and 2˜4 parts by weight of Mesima mushroom.

The antioxidant nutritional supplement according to the present invention may further comprise: based on 100 parts by weight of the vegetable mixture, 275˜520 parts by weight of spirulina; 33˜65 parts by weight of leaves and/or stems of alfalfa; 10˜20 parts by weight of grasses of barley grass; 9˜17 parts by weight of leaves of dandelion; 2.5˜5.2 parts by weight of grasses of wheat grass; 2.5˜5.2 parts by weight of leaves of melissa; 2˜4 parts by weight of grasses of lemon grass; 2˜4 parts by weight of leaves of nettle; 1.3˜2.7 parts by weight of stems, leaves, and/or flowers of blessed thistle; 1.3˜2.7 parts by weight of chlorella; 1.3˜2.7 parts by weight of leaves of plantain; 0.6˜1.4 parts by weight of blue green algae; and 0.6˜1.4 parts by weight of leaves of cilantro.

The antioxidant nutritional supplement according to the present invention may further comprise: based on 100 parts by weight of the vegetable mixture, 57˜108 parts by weight of Japanese knotweed; 154˜287 parts by weight of red wine extract; 43˜80 parts by weight of grape seed extract; and 145˜273 parts by weight of concentrated red wine powder.

The antioxidant nutritional supplement according to the present invention may further comprise: based on 100 parts by weight of the vegetable mixture, 4.5˜9.2 parts by weight of coenzyme Q10; 29˜55 parts by weight of quercetin; 5˜10 parts by weight of green tea extract; 26˜50 parts by weight of L-cysteine HCl; and 16˜31 parts by weight of grape skin.

The antioxidant nutritional supplement according to the present invention may further comprise: an enzyme mixture including 10 parts by weight of protease I; 1˜100 parts by weight of protease II; 1˜100 parts by weight of peptizyme SP; 1˜100 parts by weight of amylase; 1˜100 parts by weight of lactase; 1˜100 parts by weight of invertase; 1˜100 parts by weight of lipase; 1˜100 parts by weight of cellulase; and 1˜100 parts by weight of alpha alactosidase, wherein a weight ratio between the vegetable mixture and the enzyme mixture is 100:45˜85.

The antioxidant nutritional supplement according to the present invention may further comprise: based on 100 parts by weight of the vegetable mixture, 70˜130 parts by weight of beta carotene; 17˜33 parts by weight of retinol palmitate; 122˜228 parts by weight of sodium ascorbate; 4˜8 parts by weight of ergocalciferol; 130˜242 parts by weight of d-alpha tocopheryl succinate; 6˜12 parts by weight of phytonadione; 24˜46 parts by weight of thiamin mononitrate; 20˜38 parts by weight of riboflavin; 97˜182 parts by weight of niacinamide; 47˜90 parts by weight of pyridoxine HCl; 0.3˜0.6 parts by weight of pyridoxal 5-phosphate; 0.3˜0.7 parts by weight of folic acid; 15˜29 parts by weight of cyanocobalamin; 21˜40 parts by weight of biotin; 106˜200 parts by weight of d-calcium pantothenate; 330˜617 parts by weight of calcium citrate; 294˜548 parts by weight of calcium carbonate; 66˜123 parts by weight of Iron amino acid chelate; 128˜240 parts by weight of pacific kelp powder; 124˜232 parts by weight of magnesium oxide; 120˜224 parts by weight of magnesium citrate; 53˜100 parts by weight of Zinc amino acid chelate; 9˜19 parts by weight of L-selenomethionine; 14˜27 parts by weight of Copper amino acid chelate; 17˜34 parts by weight of Manganese amino acid chelate; 0.8˜1.6 parts by weight of chromium polynicotinate; 3.3˜6.3 parts by weight of sodium molybdate; 116˜217 parts by weight of Patassium amino acid chelate; 17˜34 parts by weight of betaine HCl; 3.4˜6.5 parts by weight of bromelain; 3.4˜6.5 parts by weight of papain; 34˜65 parts by weight of flax seed powder; 34˜65 parts by weight of sunflower seed powder; 41˜78 parts by weight of bioflavonoid complex extracted from a fruit selected from a group consisting of lemon, orange, grapefruit, lime, tangerine, and a mixture thereof; 34˜65 parts by weight of roots of siberian eleuthero; 35˜67 parts by weight of inositol; 57˜108 parts by weight of choline bitartrate; 17˜34 parts by weight of para amino-benzoic acid; 18˜35 parts by weight of rutin; 14˜27 parts by weight of Boron amino acid chelate; and 3˜6 parts by weight of lutein extracted from marigold.

The antioxidant nutritional supplement according to the present invention may have the following effects.

Firstly, since the antioxidant nutritional supplement is not a drug, it may have a low price and it may not have medical side effects even if it is taken for a long period of time.

Secondly, since the antioxidant nutritional supplement includes various nutrients with balance, it may allow a user to be provided with nutrients which may lack to modern people, without causing a difficulty in taking other nutritional supplements.

### DETAILED DESCRIPTION OF THE INVENTION

Description will now be given in detail of the present invention.

For the sake of brief description, description of the same or equivalent components will not be repeated.

An antioxidant nutritional supplement of the present invention was derived from the present inventors' recognition that a mixture of specific vegetables and a mixture of specific fruits have excellent antioxidant effects.

More concretely, a vegetable mixture according to the present invention has an antioxidant effect more excellent than that of the conventional similar vegetable mixture by three or more times, the vegetable mixture according to the present invention including 10 parts by weight of parsley juice powder, 1˜100 parts by weight of kale juice powder, 1˜100 parts by weight of spinach juice powder, 1˜100 parts by weight of wheat grass juice powder, 1˜100 parts by weight of brussels sprout juice powder, 1˜100 parts by weight of asparagus juice powder, 1˜100 parts by weight of broccoli juice powder, 1˜100 parts by weight of cauliflower juice powder, 1˜100 parts by weight of beet juice powder, 1˜100 parts by weight of carrot juice powder, 1˜100 parts by weight of cabbage juice powder, and 1˜100 parts by weight of garlic juice powder.

And, a fruit mixture according to the present invention has an antioxidant effect more excellent than that of the conventional similar fruit mixture by seven or more times, the fruit mixture according to the present invention including 10 parts by weight of plum juice powder, 1˜100 parts by weight of cranberry juice powder, 1˜100 parts by weight of blueberry juice powder, 1˜100 parts by weight of strawberry juice powder, 1˜100 parts by weight of blackberry juice powder, 1˜100 parts by weight of bilberry juice powder, 1˜100 parts by weight of cherry juice powder, 1˜100 parts by weight of apricot juice powder, 1˜100 parts by weight of papaya juice powder, 1˜100 parts by weight of orange juice powder, 1˜100 parts by weight of grape juice powder, and 1˜100 parts by weight of pineapple juice powder.

The antioxidant nutritional supplement including the vegetable mixture and the fruit mixture as indispensable ingredients provides an excellent antioxidant effect in the form of food rather than a synthetic drug. Furthermore, since the antioxidant nutritional supplement is implemented in the form of food, it is not harmful to a human's body such as digestion organs even if it is taken for a long period of time.

Preferably, a weight ratio between the vegetable mixture and the fruit mixture is 10:7˜13.

The antioxidant nutritional supplement of the present invention further comprises specific mushrooms as well as the vegetable mixture and the fruit mixture, thereby having an antifungal activity and providing nutrients which may lack to a human's body.

More concretely, the antioxidant nutritional supplement according to the present invention may further comprise: based on 100 parts by weight of the vegetable mixture, 12.5˜23.5 parts by weight of Cordyceps mushroom; 12.5˜23.5 parts by weight of Reishi mushroom; 12.5˜23.5 parts by weight of Shiitake mushroom; 12.5˜23.5 parts by weight of Hiratake mushroom; 3.3˜6.5 parts by weight of Maitake mushroom; 3.3˜6.5 parts by weight of Yamabushitake mushroom; 2˜4 parts by weight of Himematsutake mushroom; 2˜4 parts by weight of Kawaratake mushroom; 2˜4 parts by weight of Chaga mushroom; 2˜4 parts by weight of Zhu Ling mushroom; 2˜4 parts by weight of Agarikon mushroom; and 2˜4 parts by weight of Mesima mushroom.

The antioxidant nutritional supplement of the present invention further comprises green plants and algea as well as the vegetable mixture and the fruit mixture, thereby having an antioxidant effect and providing nutrients which may lack to a human's body.

More concretely, the antioxidant nutritional supplement according to the present invention may further comprise: based on 100 parts by weight of the vegetable mixture, 275˜520 parts by weight of spirulina; 33˜65 parts by weight of leaves and/or stems of alfalfa; 10˜20 parts by weight of grasses of barley grass; 9˜17 parts by weight of leaves of dandelion; 2.5˜5.2 parts by weight of grasses of wheat grass; 2.5˜5.2 parts by weight of leaves of melissa; 2˜4 parts by weight of grasses of lemon grass; 2˜4 parts by weight of leaves of nettle; 1.3˜2.7 parts by weight of stems, leaves, and/or flowers of blessed thistle; 1.3˜2.7 parts by weight of chlorella; 1.3˜2.7 parts by weight of leaves of plantain; 0.6˜1.4 parts by weight of blue green algae; and 0.6˜1.4 parts by weight of leaves of cilantro.

The antioxidant nutritional supplement of the present invention further comprises resveratrol as well as the vegetable mixture and the fruit mixture, thereby enhancing anticancer and antioxidant effects, and lowering cholesterol.

Resveratrol (trans-resveratrol) is a phytoalexin produced naturally by several plants when under attack by pathogens such as bacteria or fungi. Despite significant lay press touting resveratrol's ‘anti-aging effects’, there is little to no basis for the application of these claims to mammals (see Life-Extension section below). Resveratrol is currently a topic of numerous animal and human studies into its effects. The effects of resveratrol on the lifespan of many model organisms remain controversial, with uncertain effects in fruit flies, nematode worms, and short-lived fish. In mouse and rat experiments, anti-cancer, anti-inflammatory, blood-sugar-lowering and other beneficial cardiovascular effects of resveratrol have been reported. Most of these results have yet to be replicated in humans. In the only positive human trial, extremely high doses (3-5 g) of resveratrol in a proprietary formulation have been necessary to significantly lower blood sugar.

Resveratrol is found in the skin of red grapes and is a constituent of red wine, but apparently not in sufficient amounts to explain the French Paradox. Resveratrol has also been produced by chemical synthesis and is sold as a nutritional supplement derived primarily from Japanese knotweed.

In order to provide the resveratrol, the antioxidant nutritional supplement according to the present invention preferably further comprises, based on 100 parts by weight of the vegetable mixture, 57˜108 parts by weight of Japanese knotweed, 154˜287 parts by weight of red wine extract, 43˜80 parts by weight of grape seed extract, and 145˜273 parts by weight of concentrated red wine powder.

In order to enhance an antioxidant effect, the antioxidant nutritional supplement according to the present invention more preferably further comprises, based on 100 parts by weight of the vegetable mixture, 4.5˜9.2 parts by weight of coenzyme Q10; 29˜55 parts by weight of quercetin; 5˜10 parts by weight of green tea extract; 26˜50 parts by weight of L-cysteine HCl; and 16˜31 parts by weight of grape skin. These ingredients may prevent side effects due to oxygen free radicals inside a human's body.

The antioxidant nutritional supplement of the present invention further comprises digestive enzymes as well as the vegetable mixture and the fruit mixture, thereby allowing the antioxidant nutritional supplement and other foods to be easily digested to be absorbed.

Preferably, the antioxidant nutritional supplement according to the present invention further comprises an enzyme mixture including 10 parts by weight of protease I; 1˜100 parts by weight of protease II; 1˜100 parts by weight of peptizyme SP; 1˜100 parts by weight of amylase; 1˜100 parts by weight of lactase; 1˜100 parts by weight of invertase; 1˜100 parts by weight of lipase; 1˜100 parts by weight of cellulase; and 1˜100 parts by weight of alpha alactosidase. Here, a weight ratio between the vegetable mixture and the enzyme mixture is 100:45˜85.

The antioxidant nutritional supplement of the present invention further comprises vitamins and other nutrients which may lack to a human's body, as well as the vegetable mixture and the fruit mixture, thereby solving a user's inconvenience in taking many kinds of nutritional supplements after a meal.

More concretely, the antioxidant nutritional supplement according to the present invention preferably further comprises, based on 100 parts by weight of the vegetable mixture, 70˜130 parts by weight of beta carotene; 17˜33 parts by weight of retinol palmitate; 122˜228 parts by weight of sodium ascorbate; 4˜8 parts by weight of ergocalciferol; 130˜242 parts by weight of d-alpha tocopheryl succinate; 6˜12 parts by weight of phytonadione; 24˜46 parts by weight of thiamin mononitrate; 20˜38 parts by weight of riboflavin; 97˜182 parts by weight of niacinamide; 47˜90 parts by weight of pyridoxine HCl; 0.3˜0.6 parts by weight of pyridoxal 5-phosphate; 0.3˜0.7 parts by weight of folic acid; 15˜29 parts by weight of cyanocobalamin; 21˜40 parts by weight of biotin; 106˜200 parts by weight of d-calcium pantothenate; 330˜617 parts by weight of calcium citrate; 294˜548 parts by weight of calcium carbonate; 66˜123 parts by weight of Iron amino acid chelate; 128˜240 parts by weight of pacific kelp powder; 124˜232 parts by weight of magnesium oxide; 120˜224 parts by weight of magnesium citrate; 53˜100 parts by weight of Zinc amino acid chelate; 9˜19 parts by weight of L-selenomethionine; 14˜27 parts by weight of Copper amino acid chelate; 17˜34 parts by weight of Manganese amino acid chelate; 0.8˜1.6 parts by weight of chromium polynicotinate; 3.3˜6.3 parts by weight of sodium molybdate; 116˜217 parts by weight of Patassium amino acid chelate; 17˜34 parts by weight of betaine HCl; 3.4˜6.5 parts by weight of bromelain; 3.4˜6.5 parts by weight of papain; 34˜65 parts by weight of flax seed powder; 34˜65 parts by weight of sunflower seed powder; 41˜78 parts by weight of bioflavonoid complex extracted from a fruit selected from a group consisting of lemon, orange, grapefruit, lime, tangerine, and a mixture thereof; 34˜65 parts by weight of roots of siberian eleuthero; 35˜67 parts by weight of inositol; 57˜108 parts by weight of choline bitartrate; 17˜34 parts by weight of para amino-benzoic acid; 18˜35 parts by weight of rutin; 14˜27 parts by weight of Boron amino acid chelate; and 3˜6 parts by weight of lutein extracted from marigold.

Hereinafter, preferred embodiments of the present invention will be explained.

### PREFERRED EMBODIMENTS

### Embodiment 1

### Antioxidant Effects of Vegetable Mixture

The same amount of parsley juice powder, kale juice powder, spinach juice powder, wheat grass juice powder, brussels sprout juice powder, asparagus juice powder, broccoli juice powder, cauliflower juice powder, beet juice powder, carrot juice powder, cabbage juice powder, and garlic juice powder were mixed with one another. Then, by using a FLUOstar Galaxy plate reader (BMG Labtechnologies, Offenburg, Germany), the mixture was measured in a modified ORACFL method (Prior, R. L.; Hoang, H.; Gu, L.; Wu, X.; Bacchiocca, M.; Howard, L.; Hampsch-Woodill, M.; Huang, D.; Ou, B.; Jacob, R. Assays for hydrophilic and lipophilic antioxidant capacity (oxygen radical absorbance capacity (ORACFL)) of plasma and other biological and food samples. J. Agric. Food Chem. 2003, 51, 3273-3279.). Parameters of assay for the plate reader were as follows: cycle number, 35; cycle time, 210 s; shaking mode, 8 s orbital shaking (4 mm shake width) before each cycle; position delay, 0.3 s; injection speed, 420 iL/s for both pumps 1 and 2.

As a result of the analyses, the ORACFL of the vegetable mixture of the present invention exhibited an antioxidant capacity with a value of 1846 μmol of Trolox Equivalents/g, which was higher than the conventional antioxidant nutritional supplement having a vegetable mixture, by three times or more.

### Embodiment 2

### Antioxidant Effects of Fruit Mixture

The same amount of plum juice powder, cranberry juice powder, blueberry juice powder, strawberry juice powder, blackberry juice powder, bilberry juice powder, cherry juice powder, apricot juice powder, papaya juice powder, orange juice powder, grape juice powder, and pineapple juice powder were mixed with one another. Then, the mixture was analyzed in the same manner as that of the preferred embodiment 1.

As a result of the analyses, the ORACFL of the fruit mixture of the present invention exhibited an antioxidant capacity with a value of 1061 μmol of Trolox Equivalents/g, which was higher than the conventional antioxidant nutritional supplement having a fruit mixture, by seven times or more.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An antioxidant nutritional supplement, comprising:
a vegetable mixture including 10 parts by weight of parsley juice powder, 1˜100 parts by weight of kale juice powder, 1˜100 parts by weight of spinach juice powder, 1˜100 parts by weight of wheat grass juice powder, 1˜100 parts by weight of brussels sprout juice powder, 1˜100 parts by weight of asparagus juice powder, 1˜100 parts by weight of broccoli juice powder, 1˜100 parts by weight of cauliflower juice powder, 1˜100 parts by weight of beet juice powder, 1˜100 parts by weight of carrot juice powder, 1˜100 parts by weight of cabbage juice powder, and 1˜100 parts by weight of garlic juice powder; and
a fruit mixture including 10 parts by weight of plum juice powder, 1˜100 parts by weight of cranberry juice powder, 1˜100 parts by weight of blueberry juice powder, 1˜100 parts by weight of strawberry juice powder, 1˜100 parts by weight of blackberry juice powder, 1˜100 parts by weight of bilberry juice powder, 1˜100 parts by weight of cherry juice powder, 1˜100 parts by weight of apricot juice powder, 1˜100 parts by weight of papaya juice powder, 1˜100 parts by weight of orange juice powder, 1˜100 parts by weight of grape juice powder, and 1˜100 parts by weight of pineapple juice powder,
wherein a weight ratio between the vegetable mixture and the fruit mixture is 10:7˜13.

2. The antioxidant nutritional supplement of claim 1, further comprising, based on 100 parts by weight of the vegetable mixture:
12.5˜23.5 parts by weight of Cordyceps mushroom;
12.5˜23.5 parts by weight of Reishi mushroom;
12.5˜23.5 parts by weight of Shiitake mushroom;
12.5˜23.5 parts by weight of Hiratake mushroom;
3.3˜6.5 parts by weight of Maitake mushroom;
3.3˜6.5 parts by weight of Yamabushitake mushroom;
2˜4 parts by weight of Himematsutake mushroom;
2˜4 parts by weight of Kawaratake mushroom;
2˜4 parts by weight of Chaga mushroom;
2˜4 parts by weight of Zhu Ling mushroom;
2˜4 parts by weight of Agarikon mushroom; and
2˜4 parts by weight of Mesima mushroom.

3. The antioxidant nutritional supplement of claim 2, further comprising, based on 100 parts by weight of the vegetable mixture:
275˜520 parts by weight of spirulina;
33˜65 parts by weight of leaves and/or stems of alfalfa;
10˜20 parts by weight of grasses of barley grass;
9˜17 parts by weight of leaves of dandelion;
2.5˜5.2 parts by weight of grasses of wheat grass;
2.5˜5.2 parts by weight of leaves of melissa;
2˜4 parts by weight of grasses of lemon grass;
2˜4 parts by weight of leaves of nettle;
1.3˜2.7 parts by weight of stems, leaves, and/or flowers of blessed thistle;
1.3˜2.7 parts by weight of chlorella;
1.3˜2.7 parts by weight of leaves of plantain;
0.6˜1.4 parts by weight of blue green algae; and
0.6˜1.4 parts by weight of leaves of cilantro.

4. The antioxidant nutritional supplement of claim 3, further comprising, based on 100 parts by weight of the vegetable mixture:
57˜108 parts by weight of Japanese knotweed;
154˜287 parts by weight of red wine extract;
43˜80 parts by weight of grape seed extract; and
145˜273 parts by weight of concentrated red wine powder.

5. The antioxidant nutritional supplement of claim 4, further comprising, based on 100 parts by weight of the vegetable mixture:
4.5˜9.2 parts by weight of coenzyme Q10;
29˜55 parts by weight of quercetin;
5˜10 parts by weight of green tea extract;
26˜50 parts by weight of L-cysteine HCl; and
16˜31 parts by weight of grape skin.

6. The antioxidant nutritional supplement of claim 5, further comprising an enzyme mixture including 10 parts by weight of protease I; 1˜100 parts by weight of protease II; 1˜100 parts by weight of peptizyme SP; 1˜100 parts by weight of amylase; 1˜100 parts by weight of lactase; 1˜100 parts by weight of invertase; 1˜100 parts by weight of lipase; 1˜100 parts by weight of cellulase; and 1˜100 parts by weight of alpha alactosidase,
wherein a weight ratio between the vegetable mixture and the enzyme mixture is 100:45˜85.

7. The antioxidant nutritional supplement of claim 6, further comprising, based on 100 parts by weight of the vegetable mixture:
70˜130 parts by weight of beta carotene;
17˜33 parts by weight of retinol palmitate;
122˜228 parts by weight of sodium ascorbate;
4˜8 parts by weight of ergocalciferol;
130˜242 parts by weight of d-alpha tocopheryl succinate;
6˜12 parts by weight of phytonadione;
24˜46 parts by weight of thiamin mononitrate;
20˜38 parts by weight of riboflavin;
97˜182 parts by weight of niacinamide;
47˜90 parts by weight of pyridoxine HCl;
0.3˜0.6 parts by weight of pyridoxal 5-phosphate;
0.3˜0.7 parts by weight of folic acid;
15˜29 parts by weight of cyanocobalamin;
21˜40 parts by weight of biotin;
106˜200 parts by weight of d-calcium pantothenate;
330˜617 parts by weight of calcium citrate;
294˜548 parts by weight of calcium carbonate;
66˜123 parts by weight of Iron amino acid chelate;
128˜240 parts by weight of pacific kelp powder;
124˜232 parts by weight of magnesium oxide;
120˜224 parts by weight of magnesium citrate;
53˜100 parts by weight of Zinc amino acid chelate;
9˜19 parts by weight of L-selenomethionine;
14˜27 parts by weight of Copper amino acid chelate;
17˜34 parts by weight of Manganese amino acid chelate;
0.8˜1.6 parts by weight of chromium polynicotinate;
3.3˜6.3 parts by weight of sodium molybdate;
116˜217 parts by weight of Potassium amino acid chelate;
17˜34 parts by weight of betaine HCl;
3.4˜6.5 parts by weight of bromelain;
3.4˜6.5 parts by weight of papain;
34˜65 parts by weight of flax seed powder;
34˜65 parts by weight of sunflower seed powder;
41˜78 parts by weight of bioflavonoid complex extracted from a fruit selected from a group consisting of lemon, orange, grapefruit, lime, tangerine, and a mixture thereof;
34˜65 parts by weight of roots of siberian eleuthero;
35˜67 parts by weight of inositol;
57˜108 parts by weight of choline bitartrate;
17˜34 parts by weight of para amino-benzoic acid;
18˜35 parts by weight of rutin;
14˜27 parts by weight of Boron amino acid chelate; and
3˜6 parts by weight of lutein extracted from marigold.
